(19) United States
(12) Patent Application Publication
(10) Pub. No.: US 2015/0177389 A1
(43) Pub. Date: Jun. 25, 2015

(54) Thin Films For Radionuclide Analysis

(71) Applicant: Los Alamos National Security, LLC, Los Alamos, NM (US)

(72) Inventors: Susan Kloek Hanson, Los Alamos, NM (US); Alexander H. Mueller, Santa Fe, NM (US); Warren J. Oldham, JR., Los Alamos, NM (US)

(73) Assignee: Los Alamos National Security, LLC, Los Alamos, NM (US)

(21) Appl. No.: 14/561,077

(22) Filed: Dec. 4, 2014

Related U.S. Application Data
(60) Provisional application No. 61/920,275, filed on Dec. 23, 2013.

(51) Int. Cl. G01T 1/178

(52) U.S. Cl. CPC G01T 1/178

(57) ABSTRACT

A rapid and effective process to analyze for plutonium and other actinide metals affords a high chemical yield and provides isotopic information for forensic evaluation. The process employs alpha spectrometry of films of tripodal oxygen donor ligands. The films were prepared by spin-casting solutions onto glass substrates. Three different ligands were evaluated for plutonium binding. The best results were obtained using the ethyl-substituted complex Na[Cp*Co(P(O)(OEt)₂)₃], which bound 80-99% of the dissolved plutonium under equilibrium conditions. The thin films exhibit excellent alpha spectral resolution with line widths of approximately 33 keV. The method has been successfully applied to analyze for plutonium in both an archived nuclear debris sample and a certified environmental soil sample. The results obtained from the soil analysis are in good agreement with the certified values, demonstrating the effectiveness of the method for rapid plutonium analysis.

### PRIORITY CLAIM TO COPENDING PROVISIONAL APPLICATION

This application claims the benefit of U.S. Provisional Patent Application No. 61/920,275 entitled “Thin Films for Radionuclide Analysis,” filed Dec. 23, 2013, which is hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to thin films and more particularly to the use of thin films for radionuclide analysis by alpha spectrometry.

### BACKGROUND OF THE INVENTION

A growing concern over the possibility of a terrorist radiological attack or other nuclear incident is driving research in nuclear forensic analysis, which is the analysis for radionuclides from debris or other samples taken from the incident. Nuclear forensic analysis may provide information about the incident, such as information about any devices or materials involved. Nuclear forensic analysis for debris that contains plutonium, for example, would involve an analysis of the isotopic composition, which may help identify the source and perhaps those responsible for the incident or attack. A fast, accurate, and reliable process for analyzing radionuclides such as plutonium (“Pu”) is crucial for a suitable response. Consequently, there is a need for rapid and simple processes to analyze for plutonium and other actinide metals.

A traditional analysis for plutonium involves radiochemical separation of plutonium from matrix elements, followed by alpha spectrometry. High-quality alpha spectra can resolve the different plutonium isotopes. Samples are prepared, typically by electroplating. Electroplating is a relatively sophisticated and somewhat time-consuming sample preparation process that results in a layer so thin that it limits the attenuation of alpha particles, which reduces spectral resolution.

An alternative approach to electroplating would be to use a monolayer or thin film of a compound that acts as a ligand to bind radionuclides from solution. After exposure to the radionuclides, the thin film would bind to the radionuclides and provide a surface for alpha spectrometry. Past efforts to develop monolayers or thin films to analyze for radionuclides by alpha spectrometry have suffered from poor spectral resolution or low chemical yields.

### SUMMARY OF THE INVENTION

An embodiment relates to a process to analyze for a radionuclide. The embodiment process comprises forming an aqueous acidic first solution, forming a second solution comprising a compound of the formula Na[Cp*Co(P(O)(OR)₂)₃] wherein R is alkyl having at least two carbons, casting a film of the compound from the second solution, the film being substantially insoluble in water, contacting the film with the first solution under conditions that allow radionuclides present in the first solution to bind to the film, and thereafter subjecting the film to alpha spectrometry.

Another embodiment relates to a nuclear forensic analysis process. The embodiment nuclear forensic process comprises forming an aqueous acidic first solution from debris from a nuclear incident, forming a second solution comprising a compound of the formula Na[Cp*Co(P(O)(OR)₂)₃] wherein R is alkyl having at least two carbons, casting a film of the compound from the second solution, the film being substantially insoluble in water, contacting the film with the first solution under conditions that allow radionuclides present in the first solution to bind to the film, and thereafter subjecting the film to alpha spectrometry.

Yet another embodiment relates to a process to analyze soil for a radionuclide. This embodiment process for analyzing soil for a radionuclide comprises forming an aqueous acidic first solution from a sample of soil, forming a second solution comprising a compound of the formula Na[Cp*Co(P(O)(OR)₂)₃] wherein R is alkyl having at least two carbons, casting a film of the compound from the second solution, the film being substantially insoluble in water, contacting the film with the first solution under conditions that allow radionuclides present in the first solution to bind to the film, and thereafter subjecting the film to alpha spectrometry.

### DETAILED DESCRIPTION

An embodiment process to analyze for radionuclides involves preparation of a thin film of a compound of the formula Na[CpCo(P(O)(OR)₂)₃], exposing the thin film to aqueous acidic solution, and then analyzing the thin film for bound radionuclides using alpha spectrometry. A schematic drawing showing the structure without the sodium ion is shown below.

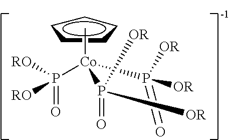

These compounds are sometimes referred to in the art as “Kläui ligands” because they have been studied extensively by Kläui and coworkers and they are known for their ability to act as chelating ligands that form coordination complexes with transition metals, lanthanides, and actinides. Others have prepared a chromatographic resin including a small amount of a cyclopentadienyldialkylphosphito-cobalt compound that was used in column chromatography of plutonium.

The thin films used with the embodiment process were prepared by spin casting. The thin films were then exposed to solutions, and afterward, the thin films were analyzed for a bound radionuclide (such as plutonium) using alpha spectrometry. All samples that contained plutonium were handled in an approved radiological facility, and all of the samples and the glassware that contacted plutonium were disposed using a low-level radioactive waste stream.

Some of the cyclopentadienyldialkylphosphito-cobalt-type compounds are available commercially. One was prepared using a literature procedure. A 2-ethylhexyl substituted compound is a new compound to our knowledge. A variety of spectroscopic and analytical techniques were used to characterize the compounds, including nuclear magnetic resonance spectroscopy, infrared spectroscopy, UV-visible spectroscopy, and elemental analysis. Chemical shifts (δ) were referenced to the residual solvent signal (¹H and ¹³C for proton and carbon spectra, respectively) or referenced externally to H₃PO₄ (for ³¹P spectra, 0 ppm). Ellipsometry data was recorded on a spectroscopic ellipsometer at an incident angle of 70° over a wavelength range of 380-900 nm. A Cauchy dispersion function was used to obtain the best fits of the optical functions and thickness values for the films spin-cast on Si wafers. The dispersion function values for n+k were refined until consistent thickness values were obtained.

Na[CpCo(P(O)(OCH₃)₂)₃] (compound 1) was purchased from STREM CHEMICAL.

Na[Cp*Co(P(O)(OCH₂CH₃)₂)₃] (compound 2) was prepared according to procedure known in the art.

[Cp*Co(P(O)(OR)₂)₃]₂Co (R=2-ethylhexyl, compound 3) and Na[Cp*Co(P(O)(OR)₂)₃] (R=2-ethylhexyl, compound 4) were prepared according to the procedures below. Compound 3 was prepared first, and then used as a precursor for preparing compound 4. Details of the experimental procedures and analyses are provided below.

Compound 3 was prepared as follows: a mixture of potassium pentamethylcyclopentadienide (KCp*, 1.505 grams, 8.650 millimoles) and Co(acac)₃ (1.531 grams, 4.301 millimoles) in THF (20 mL) in a 50 mL round bottom flask was prepared in a drybox. The mixture was stirred overnight to give a brown suspension. The brown suspension was filtered to give a solid. The solid was washed with THF (3×5 mL). The solvent from the filtrate was removed to afford a dark brown oil. Bis(2-ethylhexyl)phosphite (7.40 grams, 24.2 millimoles) was added to the brown oil to provide a mixture that was then heated 105° C. with stirring for 72 hours. The reaction mixture was cooled to room temperature and removed from the drybox. Addition of cold methanol (30 mL) resulted in the formation of a bright yellow precipitate. The yellow solid was washed with cold methanol (2×10 mL) and dried under vacuum to yield 1.677 grams (51%) of compound 3. ¹H NMR (400 MHz, benzene-d₆): δ 21.01 (singlet, 30H, Cp*), −0.01 to −0.46 (multiplet, 34

H, —OR), −0.80 to −3.73 (broad multiplet, 86H, —OR), −4.45 to −7.99 (broad multiplet, 78H, —OR), −9.72 (broad singlet, 6H, —OR). Magnetic moment (Evans Method): μ_{eff}=5.2μ_{B}. IR (thin film): ν_{C-O-P}=1127 cm−1, ν_{P-O=}=599 cm−1. HRMS (EI): m/z calculated for C₁₁₆H₂₃₄Co₃O₁₈P₆ [M]+2278.3817; found 2278.3732.

Compound 4 was prepared in the air as follows. A suspension of compound 3 (0.773 grams, 0.34 millimoles) and NaCN (0.235 grams, 4.8 millimoles) in a solvent mixture of dichloromethane (30 mL) and methanol (30 mL) was prepared and stirred at room temperature for 24 hours. Additional NaCN was added (0.213 grams, 4.3 millimoles) and the stirring was continued at room temperature for another 24 hours, after which the solvent was removed under vacuum to provide a yellow residue. The yellow residue was extracted with diethyl ether (3×1 mL), filtered, and the filtrate was removed under vacuum, leaving a crude yellow residue. The crude yellow residue was purified by chromatography on silica gel using a 7:3 mixture of hexane/ethyl acetate to produce 0.271 grams (35%) of compound 4. ¹H NMR (400 MHz, dichloromethane): 3.92-3.60 (multiplet, 12H, P—OCH₂), 1.67 (singlet, 15H, Cp*), 1.59-1.20 (multiplet, 56H, 2-ethylhexyl), 0.92-0.85 (multiplet, 34H, 2-ethylhexyl). ³¹P{¹H} NMR (162 MHz, dichloromethane): 108.3 (singlet). ¹³C{¹H} NMR (100 MHz, dichloromethane): 99.8 (singlet), 66.4 (multiplet), 40.9 (singlet), 30.8 (doublet, J_{C-P}=12 Hz), 29.6 (multiplet), 23.9 (singlet), 23.7 (doublet, J_{C-P}=26 Hz), 14.5 (singlet), 11.4 (multiplet), 11.3 (singlet). IR (thin film): ν_{C-O-P}=1137 cm−1, ν_{P=O}=594 cm−1. UV-vis: λ=370 nm, ε=3800 M⁻¹ cm⁻¹. Analysis calculated for C₅₈H₁₁₇CoNaO₉P₃: C, 61.46; H, 10.40. Found: C, 61.51; H, 10.30.

Thin films of compounds 1, 2 and 4 were prepared by spin-casting using a spin coater. Casting solutions of compound 1 in 1-butanol (2 millimolar), and compounds 2 and 4 in toluene (2 millimolar), were prepared. The films were cast onto clean circular 25 millimeter (“mm”) diameter microscope glass coverslips. A 200 microliter (“μL”) aliquot of the casting solution was applied to a glass coverslip that was spinning at approximately 800 rotations per minute (“rpm”) for 10 seconds. The spinning rate was then increased to approximately 3600 rpm and spinning continued for 30 seconds. The thin film was allowed to remain on the glass coverslip for the next step, which was contacting the thin film with a plutonium-containing solution.

A plutonium-containing solution (200 μL of a 0.1 molar HNO₃ solution) was carefully added onto the surface of the thin film using an automatic pipettor (2×100 μL transfers). The solution formed a bead on the surface and was allowed to equilibrate for 30 minutes while covered with a beaker to minimize evaporation. After the equilibration period, the solution was removed from the surface using the automatic pipettor, and any remaining droplets were absorbed with a disposable KIMWIPE. Alpha spectra of the surface were recorded using an ORTEC OCTETE +8-channel alpha spectrometer equipped with a 19 keV fwhm 300 mm² Si-detector.

Plutonium purification was performed using a LaF₃ co-precipitation followed by an anion exchange column (involving a chemical separation using the anion exchange resin AG-MP 1M 50-100 mesh, a procedure known in the art.)

Ellipsometry measurements were performed to estimate the thickness of the thin films. Compound 1 was too water soluble to use in thin film binding experiments so it was not characterized any further. Thin films of compound 2 and compound 4 were prepared by spin-casting on two-inch silicon wafers. The Ellipsometry data indicated a thickness of approximately 10 mm for the thin film of compound 2, and a thickness of approximately 19 mm for the thin films of compound 4.

Thin films of compounds 1, 2, and 4 were evaluated for plutonium binding by contacting each thin film with a small amount of a solution containing Pu^{IV}. In a typical experiment, a glass disk with a spin-cast film was exposed to 200 μL of a Pu^{IV}-containing aqueous acidic solution (0.1 M HNO₃). After 30 minutes of contact, the solution remaining on the film was removed and the amount of plutonium binding to each thin film was assessed by alpha spectrometry.

Little or no Pu^{IV} binding was observed for thin films of complex 1.

Approximately 80% of the dissolved Pu^{IV} was bound to the thin film of compound 2 after 30 minutes of contact.

Approximately 64% of the dissolved Pu^{IV} was bound to the thin film of compound 4 after 30 minutes of exposure.

A control experiment was performed in which the glass disk (without any thin film) was contacted with the same amount of plutonium-containing solution for 30 minutes. Only about 3% of plutonium was adsorbed onto the surface of the glass disk.

Thin films of compound 2 were used in the remaining experiments.

Thin films of complex 2 were prepared and treated with a Pu^{IV}-containing solution for 15, 30, or 45 minutes to determine the amount of time needed for plutonium binding to reach equilibrium. At least three independent experiments were performed at each exposure time. After 30 minutes, no further increase in the percentage of plutonium binding was observed, suggesting that equilibrium conditions were obtained at or before 30 minutes of contact time (FIG. 4).

Some of the binding experiments were repeated with Pu^{III} instead of Pu^{IV} in 0.1 M HNO₃ solution. The Pu^{III} binding was nearly identical to the Pu^{IV} binding to thin films of compound 2. After exposing the thin films to the Pu^{IV}-containing solution for 30 minutes, and removal of excess solution from the surface, the films were analyzed by alpha spectrometry. Alpha spectra were recorded using a 19 keV fwhm 300 mm² Si-detector, with the glass substrates placed 5 mm below the detector. The line width (fwhm) was approximately 33 keV. The spectral resolution compares favorably to other recently reported methods for actinide analysis based on thin films and coatings.

Thin films of compound 2 were prepared and contacted with solutions of Pu^{IV} that spanned a range of activities (0.02 Bq to 76 Bq). At lower activities from 0.02 Bq to 1.7 Bq, plutonium absorption increased linearly with increasing activity, and the films bound approximately 88% of the exposed activity. There was some deviation in binding at higher activities from 7 Bq to 76 Bq, which suggests saturation behavior. At the upper limit (76 Bq) of our tests, approximately 50% of the dissolved Pu was bound to the film, resulting in a total surface activity of approximately 37 Bq (about 3.9×10¹³ atoms), which demonstrates that the embodiment thin films of compound 2 operated under a much wider dynamic range than a previously reported monolayer system, in which the total binding capacity was limited to approximately 20 Bq, which is approximately 2.1×10¹³ atoms.

The effects of Pu^{IV} binding as a function of acid (HNO₃ vs. HCl) and acid concentration (0.1 M to 5 M) were examined. Generally, the percentage of dissolved Pu^{IV} that bound to the thin film decreased as the acid concentration increased. For example, approximately 40% of dissolved Pu^{IV} was bound to a thin film of compound 2 from a Pu^{IV}-containing 5.0 M HNO₃ solution, compared to a value of approximately 80% of dissolved Pu^{IV} from a Pu^{IV}-containing 0.1 M HNO₃ solution. The Pu^{IV} binding in HCl solutions also decreased as the acid concentration increased. Only about 3% of dissolved Pu^{IV} was bound to the thin film of compound 2 in a Pu^{IV}-containing 5.0 M HCl solution. Thus, acid concentration and type play a role in binding affinity of Pu^{IV} to the thin films.

Evaluations of binding were also made for solutions having different ionic strengths. For example, binding experiments were carried out in 0.1 M HNO₃ solutions with and without various amounts of NaNO₃ (0-5.0 M). As the amount of NaNO₃ in the solution increased, the percentage of dissolved Pu^{IV} that was bound to the thin film decreased. For example, approximately 60% Pu^{IV} binding was observed in a solution of 0.1 M HNO₃ that was also 5.0 M in NaNO₃, compared to approximately 80% of Pu^{IV} binding in a solution of 0.1 M HNO₃ without any added NaNO₃.

To evaluate the potential use of the thin films for field samples, analysis of a nuclear glass debris sample was performed. The sample was dissolved as a 3 M HCl solution and was purified by pre-concentration of the actinides using a LaF₃ precipitation, followed by an anion exchange column. Sample purification took about 1-2 hours. The purified plutonium fraction was then exposed to the thin film as a 200 μL solution in 0.1 M HNO₃ and allowed to equilibrate over a 30 minute period. The solution was removed, and the thin film was characterized by alpha spectrometry. The alpha spectra of the thin film displayed a resolution similar to the resolution obtained for an alpha spectrum of a film prepared by electroplating. These results suggest that the embodiment method can be used for analyzing samples obtained from debris from a nuclear incident. For forensic applications, long-term storage and archiving of samples may be needed. When a thin film sample was archived for 8 months and then re-counted, no degradation of the sample or loss of spectral resolution was observed.

To further assess the use of the embodiment thin films for environmental samples, a sample of contaminated Rocky Flats soil (NIST Standard Reference Material 4353A) was analyzed for plutonium. An aliquot of the soil (941 mg dissolved in 3 M HCl) was spiked with a known amount of a ²⁴²Pu tracer (70 mBq), and the sample was purified for plutonium using the LaF₃ co-precipitation/ion exchange method. The plutonium fraction was then dissolved in 0.1 M HNO₃ (200 μL) and exposed to a thin film of compound 2 for 30 minutes. An alpha spectrum of the thin film after exposure was obtained. The line width of the alpha spectrum is approximately 35 keV, allowing for excellent resolution of the ²⁴²Pu and ^{239/240}Pu peaks. For the soil analysis, the overall yield was reduced to approximately 45% as compared to approximately 70% yield on an identical process blank with no soil, suggesting that the soil matrix interferes somewhat with plutonium binding. However, the experimentally determined value for the ^{239/240}Pu activity in the soil (16±0.7 mBq/g) is in good agreement with the certified value (16.8±1.8 mBq/g), demonstrating the efficacy of the thin films as a method for the analysis of plutonium in environmental samples.

In summary, there is a need for a field-ready, rapid, and simple process for the analysis of plutonium and other actinide metals for forensic applications. A process that can provide a high chemical yield of these elements, while not compromising the resolution of isotopic information is desirable. Embodiments that employ the thin films of Na[Cp*Co(P(O)(OR)₂)₃] wherein R is alkyl having at least two carbons (e.g. compound 3 and compound 4) are promising for plutonium analysis. The embodiments provide for a high plutonium binding affinity (i.e. high radiochemical yield) and an excellent alpha spectral resolution.

Although the present invention has been described with reference to specific details, it is not intended that such details should be regarded as limitations upon the scope of the invention, except as and to the extent that they are included in the accompanying claims.

What is claimed is:

1. A process to analyze for a radionuclide, comprising:
forming an aqueous acidic first solution,
forming a second solution comprising a compound of the formula Na[Cp*Co(P(O)(OR)₂)₃] wherein R is alkyl having at least two carbons,
casting a film of the compound from the second solution, the film being substantially insoluble in water,
contacting the film with the first solution under conditions that allow radionuclides present in the first solution to bind to the film, and thereafter
subjecting the film to alpha spectrometry.

2. The process of claim 1, wherein R is primary alkyl.

3. The process of claim 1, wherein alkyl is ethyl.

4. The process the process of claim 1, wherein the radionuclide is plutonium.

5. The process of claim 1, wherein the first aqueous acidic solution comprises an acid selected from nitric acid or hydrochloric acid.

6. The process of claim 1, wherein the first aqueous acidic solution comprises an acid concentration of less than about 5 M.

7. A process of claim 1, wherein the step of casting is performed on a glass substrate.

8. A nuclear forensic analysis process comprising:
forming an aqueous acidic first solution from debris from a nuclear incident,
forming a second solution comprising a compound of the formula Na[Cp*Co(P(O)(OR)₂)₃] wherein R is alkyl having at least two carbons,
casting a film of the compound from the second solution, the film being substantially insoluble in water,
contacting the film with the first solution under conditions that allow radionuclides present in the first solution to bind to the film, and thereafter
subjecting the film to alpha spectrometry.

9. The process of claim 8, wherein R is primary alkyl.

10. The process of claim 8, wherein alkyl is ethyl.

11. The process the process of claim 8, wherein the radionuclide is plutonium.

12. The process of claim 8, wherein the first aqueous acidic solution comprises an acid selected from nitric acid or hydrochloric acid.

13. The process of claim 8, wherein the first aqueous acidic solution comprises an acid concentration of less than about 5 M.

14. A process to analyze soil for a radionuclide:
forming an aqueous acidic first solution from a sample of soil,
forming a second solution comprising a compound of the formula Na[Cp*Co(P(O)(OR)₂)₃] wherein R is alkyl having at least two carbons,
casting a film of the compound from the second solution, the film being substantially insoluble in water,
contacting the film with the first solution under conditions that allow radionuclides present in the first solution to bind to the film, and thereafter
subjecting the film to alpha spectrometry.

15. The process of claim 14, wherein R is primary alkyl.

16. The process of claim 14, wherein alkyl is ethyl.

17. The process claim 14, wherein the radionuclide is plutonium.

18. The process of claim 14, wherein the first aqueous acidic solution comprises an acid selected from nitric acid or hydrochloric acid.

19. The process of claim 14, wherein the first aqueous acidic solution comprises an acid concentration of less than about 5 M.

20. A thin film for analyzing radionuclides, said thin film comprising a compound of the formula Na[Cp*Co(P(O)(OR)₂)₃] wherein R is alkyl having at least two carbons.

21. The thin film of claim 20, wherein R is ethyl.
